(19) United States
(12) Patent Application Publication
(10) Pub. No.: US 2025/0130674 A1
(43) Pub. Date: Apr. 24, 2025

(54) TOUCH PANEL, DISPLAY PANEL AND DISPLAY APPARATUS

(71) Applicant: Hefei Visionox Technology Co., Ltd., Hefei (CN)

(72) Inventors: Bing TAN, Hefei (CN); Qi ZHOU, Hefei (CN); Guizhou QIAO, Hefei (CN)

(73) Assignee: Hefei Visionox Technology Co., Ltd., Hefei (CN)

(21) Appl. No.: 19/005,329

(22) Filed: Dec. 30, 2024

Related U.S. Application Data
(63) Continuation of application No. 18/169,395, filed on Feb. 15, 2023.
Application No. 18/169,395 is a continuation of application No. PCT/CN2021/124547, filed on Oct. 19, 2021.

(30) Foreign Application Priority Data
Nov. 20, 2020 (CN) 202011313897.5
Dec. 2, 2020 (CN) 202011388552.6
Sep. 8, 2021 (CN) 202111048711.2

(51) Int. Cl. G06F 3/044

(52) U.S. Cl. CPC G06F 3/0443; G06F 3/0446; G06F 2203/04102; G06F 2203/04111

(57) ABSTRACT

This application relates to a touch panel, a display panel and a display apparatus. The touch panel includes a touch region and a peripheral region arranged around the touch region, the touch panel includes a metal layer and at least two insulation layers stacked along a first direction, at least one of the at least two insulation layers includes an organic material and at least one of the at least two insulation layers includes an inorganic material, the metal layer includes a plurality of touch electrodes and metal wirings connected to the touch electrodes, the touch electrodes are arranged in the touch region, and the metal wirings are arranged in the peripheral region. An orthographic projection along the first direction of at least one of the insulation layers disposed in the peripheral region is smaller in area than the peripheral region along the first direction.

### CROSS-REFERENCE TO RELATED APPLICATIONS

This application is a continuation of U.S. patent application Ser. No. 18/169,395, filed on Feb. 15, 2023, which is a continuation of International Application No. PCT/CN2021/124547, filed on Oct. 19, 2021, which claims priority to Chinese Patent Application No. 202011313897.5, filed on Nov. 20, 2020, Chinese Patent Application No. 202011388552.6, filed on Dec. 2, 2020, Chinese Patent Application No. 202111048711.2, filed on Sep. 8, 2021, all of which are hereby incorporated by reference in their entireties.

### TECHNICAL FIELD

The present application relates to the field of display technology, and particularly relates to a touch panel, a display panel and a display apparatus.

### BACKGROUND

With development of display technology and popularization of electronic products, a requirement of functionality of a display panel is getting higher and higher. Bendable display panels are the technology and market trend in the current display industry, and most of them have touch functionality. Therefore, bendable touch panels emerge.

For an existing touch panel with bendable property, in order to ensure its desired bending property, generally, all insulation layers of the touch panel are made of an organic material. Although the bending performance of the touch panel can be improved, formation of metal wirings in the touch panel is affected, so that touch panel yield is low.

### SUMMARY

Embodiments of the present application provide a touch panel, a display panel and a display apparatus, wherein functionality of bending and touch can be integrated into the touch panel without affecting formation of metal wirings in the touch panel, which improves touch panel yield.

In an aspect, an embodiment of the present application provides a touch panel, comprising: a touch region and a peripheral region arranged around the touch region, a metal layer comprising a plurality of touch electrodes arranged in the touch region and a plurality of metal wirings connected to the touch electrodes and arranged in the peripheral region; and at least two insulation layers stacked with the metal layer along a first direction, at least one of the at least two insulation layers comprising an organic material and at least one of the at least two insulation layers comprising an inorganic material; and wherein an orthographic projection along the first direction of at least one of the insulation layers disposed in the peripheral region is smaller in area than the peripheral region along the first direction.

In another aspect, an embodiment of the present application further provides a display panel including the touch panel according to any one of the above implementations.

In yet another aspect, an embodiment of the present application provides a display apparatus including the display panel according to the above embodiments.

The embodiments of the present application provide the touch panel, the display panel and the display apparatus. The touch panel includes the touch region and the peripheral region arranged around the touch region, and includes the metal layer and two or more insulation layers stacked along the first direction. At least one of the two or more insulation layers includes the organic material and at least one of the two or more insulation layers includes the inorganic material. The metal layer includes the plurality of touch electrodes and the metal wirings connected to the plurality of touch electrodes. Thus, a protection requirement of the metal layer can be satisfied, and at the same time, a bendability property of the touch panel can be ensured. In addition, the orthographic projection along the first direction of at least one of the insulation layers disposed in the peripheral region is smaller in area than the peripheral region along the first direction. A part or all of layer structure of at least one of the insulation layers in the peripheral region is removed to reduce adverse influence of the insulation layer on a forming process of the metal wirings, which improves a process yield of the metal wirings in the touch panel, and therefore improves touch panel yield.

### BRIEF DESCRIPTION OF THE DRAWINGS

Features, advantages and technical effects of exemplary embodiments of the present application will be described below with reference to the accompanying drawings, which are not drawn to scale.

FIG. 1 is a schematic top view of a touch panel according to an embodiment of the present application.

FIG. 2 is a cross-sectional view along B-B in FIG. 1 of an embodiment of the present application.

FIG. 3 is a cross-sectional view along B-B in FIG. 1 of another embodiment of the present application.

FIG. 4 is a magnified view at W in FIG. 1 of an embodiment of the present application.

FIG. 5 is a cross-sectional view along B-B in FIG. 1 of yet another embodiment of the present application.

FIG. 6 is a magnified view at D in FIG. 1.

FIG. 7 is a partial magnified view of a touch panel in a peripheral region according to another embodiment of the present application.

FIG. 8 is a partial magnified view of a touch panel in a peripheral region according to yet another embodiment of the present application.

FIG. 9 is a partial magnified view of a touch panel in a peripheral region according to yet another embodiment of the present application.

FIG. 10 is a cross-sectional view along C-C in FIG. 1.

FIG. 11 is a cross-sectional view of a touch panel in a peripheral region according to yet another embodiment of the present application.

FIG. 12 is a cross-sectional view of a touch panel in a peripheral region according to yet another embodiment of the present application.

FIG. 13 is a magnified view at W in FIG. 1 of another embodiment of the present application.

FIG. 14 is a cross-sectional view along B-B in FIG. 1 of yet another embodiment of the present application.

FIG. 15 is a cross-sectional view along C-C in FIG. 1 of another embodiment.

FIG. 16 is a cross-sectional view of a touch panel in a peripheral region according to yet another embodiment of the present application.

FIG. 17 is a cross-sectional view of a touch panel in a peripheral region according to yet another embodiment of the present application.

FIG. 18 is a schematic top view of a touch panel according to another embodiment of the present application.

FIG. 19 is a cross-sectional view along E-E in FIG. 18.

FIG. 20 is a schematic top view of a touch panel according to yet another embodiment of the present application.

FIG. 21 is a schematic cross-sectional structural view of a display panel according to an embodiment of the present application.

FIG. 22 is a schematic cross-sectional structural view of a display panel according to another embodiment of the present application.

### DETAILED DESCRIPTION

Features and exemplary embodiments of various aspects of the present application are described in detail below. In the following detailed description, numerous specific details are presented to provide a thorough understanding of the present application. However, it will be apparent for those skilled in the art that the present application may be implemented without some of these specific details. The following description of the embodiments is merely for providing a better understanding of the present application by illustrating examples of the present application. In the drawings and the following description, at least some of well-known structures and techniques have not been shown to avoid unnecessary obscurity of the present application. In addition, size of some structures may be exaggerated for clarity. Furthermore, the features, structures, or characteristics described below may be combined in one or more embodiments by any suitable manner.

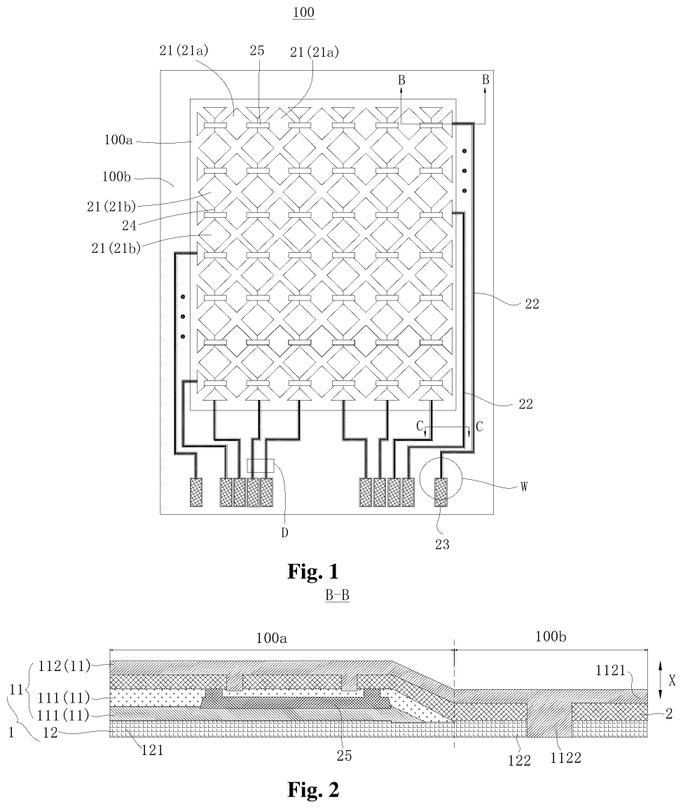

For a better understanding of the present application, a touch panel, a display panel, and a display apparatus according to implementations of the present application will be described in details below with reference to FIG. 1 to FIG. 22.

As shown in FIG. 1 to FIG. 3, an embodiment of the present application provides a touch panel 100 including a touch region 100a and a peripheral region 100b arranged around the touch region 100a. The touch panel 100 includes a metal layer 2 and at least two insulation layers 1 stacked along a first direction X. At least one of the at least two insulation layers 1 includes an organic material. In addition, at least the other one of the at least two insulation layers 1 includes an inorganic material. The metal layer 2 includes a plurality of touch electrodes 21 and metal wirings 22 connected to the plurality of touch electrodes 21. The touch electrodes 22 are arranged in the touch region 100a, and the metal wirings 22 are arranged in the peripheral region 100b. An orthographic projection along the first direction X of at least one of the insulation layers 1 disposed in the peripheral region 100b is smaller in area than the peripheral region 100b along the first direction X.

In the touch panel 100 according to an embodiment of the present application, the touch panel 100 includes the metal layer 2 and the two or more insulation layers 1 stacked along the first direction X. At least one of the two or more insulation layers 1 includes the organic material and at least the other one of the two or more insulation layers 1 includes the inorganic material. The metal layer 2 includes the plurality of touch electrodes 21 and the metal wirings 22 connected to the plurality of touch electrodes 21. This can satisfy protection requirement of the metal layer 2, and at the same time ensure a bendability property of the touch panel 100. In addition, the orthographic projection along the first direction X of at least one of the insulation layers 1 disposed in the peripheral region 100b is smaller in area than the peripheral region 100b along the first direction X. A part or all of layer structure of at least one of the insulation layers 1 in the peripheral region 100b is removed to reduce adverse influence of the insulation layer 1 on a forming process of the metal wirings 22, which improves a process yield of the metal wirings 22 in the touch panel 100, and therefore improves a yield of the touch panel 100.

Optionally, the first direction X may be a direction along which the metal layer 2 and the insulation layers 1 are stacked. The insulation layers 1 are not limited in number. The insulation layers 1 may include one or more layers of organic material and one or more layers of an inorganic material. The orthographic projection along the first direction X of at least one of the insulation layers 1 disposed in the peripheral region 100b is smaller in area than the peripheral region 100b along the first direction X, that is, the orthographic projection of at least one of the insulation layers 1 along the first direction X is at least partially not overlapped with the orthographic projection of the peripheral region 100b along the first direction X, or the orthographic projection of at least one of the insulation layers 1 along the first direction X does not overlap all of the orthographic projection of the peripheral region 100b along the first direction X. An orthographic projection of at least one of the insulation layers 1 including organic material along the first direction X may be set smaller in area than the orthographic projection of the peripheral region 100b along the first direction X, or an orthographic projection of at least one of the insulation layers 1 including inorganic material along the first direction X may be set smaller in area than the orthographic projection of the peripheral region 100b along the first direction X, and any one of these setting manners may be selected as needed.

It should be noted that, the touch panel 100 includes a touch surface. As described in the present application, the orthographic projection of at least one of the insulation layers 1 or the peripheral region 100b along the first direction X may be an orthographic projection of the at least one of the insulation layers 1 or the peripheral region 100b on the touch surface along the first direction X, or may be an orthographic projection of the at least one of the insulation layers 1 or the peripheral region 100b on a plane where at least one metal layer 2 is positioned along the first direction X. When the metal layer 2 is a plane as a whole, the plane where the metal layer 2 is positioned is parallel to or coincides with the touch surface.

Optionally, in the peripheral region 100b, there may be many setting manners in which the orthographic projection along the first direction X of at least one of the insulation layers 1 is smaller in area than the peripheral region 100b along the first direction X, and any suitable one of these setting manners may be selected. In an example, at least one of the insulation layers 1 may be provided only in the touch region 100a and not in the peripheral region 100b, or at least one of the insulation layers 1 may be provided both in the touch region 100a and in the peripheral region 100b, and be patterned in the peripheral region 100b, so that the orthographic projection along the first direction X of at least one of the insulation layers 1 is smaller in area than the peripheral region 100b.

Optionally, some or all of material of an insulation layer 1 may be organic material. When the material of the insulation layer 1 includes organic material, the insulation layer 1 is an organic material layer. Similarly, some or all of material of an insulation layer 1 may be inorganic material. When the material of the insulation layer 1 includes inorganic material, the insulation layer 1 is inorganic material layer.

Optionally, two or more insulation layers 1 may be provided on one side of the metal layer 2 along the first direction X, or at least one of the insulation layers 1 may be provided on each of both sides of the metal layer 2 along the first direction X.

In some embodiments, a number of the insulation layers 1 is greater than or equal to three, and the insulation layers 1 include one or more first insulation layers 11 including the organic material and one or more second insulation layers 12 including the inorganic material. That is, the first insulation layer 11 is an organic material layer, and the second insulation layer 12 is an inorganic material layer.

Optionally, the number of the insulation layers 1 may be three, four or more. In an embodiment where the number of the insulation layers 1 is three, the three insulation layers 1 may include one first insulation layer 11 and two second insulation layers 12, or may include two first insulation layers 11 and one second insulation layer 12. The three insulation layers 1 may all be provided on one side of the metal layer 2 along the first direction X, and the second insulation layer 12, the two first insulation layers 11 and the metal layer 2 are provided sequentially along the first direction X. The three insulation layers 1 may be provided on both sides of the metal layer 2 along the first direction X, that is, the second insulation layer 12, the first insulation layer 11, the metal layer 2 and the first insulation layer 11 are provided sequentially along the first direction X.

In an embodiment where the number of the insulation layers 1 is four, one second insulation layer 12 and three first insulation layers 11 may be provided, where the second insulation layer 12, two first insulation layer 11, the metal layer 2 and the first insulation layer 11 are provided sequentially along the first direction X.

The organic material can improve a bending property of the touch panel 100, and the inorganic material can prevent water and oxygen outside from entering inside the touch panel 100, thereby providing the touch panel 100 with the one or more first insulation layers 11 and the one or more second insulation layers 12 at the same time can ensure the bending property of the touch panel 100, and at the same time, can improve an ability of the touch panel 100 to prevent water and oxygen, which reduces a risk of short circuit or open circuit of the metal wirings 22 in the touch panel 100.

In some embodiments, as shown in FIG. 2 and FIG. 3, the number of the first insulation layers 11 is at least two, and the at least two first insulation layers 11 include one or more interlayer insulation layers 111 and an edge insulation layer 112. A side of the edge insulation layer 112 away from the metal layer 2 may be provided with a structure such as a cover plate, or may be provided with no further structure. An orthographic projection of the at least one of the interlayer insulation layers 111 along the first direction X is disposed outside the peripheral region 100b. An orthographic projection of the edge insulation layer 112 along the first direction X covers both the touch region 100a and the peripheral region 100b (that is, the orthographic projection of the edge insulation layer 112 along the first direction X covers the orthographic projection of the touch region 100a and the orthographic projection of the peripheral region 100b).

Optionally, a number of the interlayer insulation layers 111 may be one or two. The edge insulation layer 112 is provided in the touch region 100a and the peripheral region 100b, and the at least one of the interlayer insulation layers 111 is provided only in the touch region 100a, but not in the peripheral region 100b. As such, an etching process for the metal wirings 22 on the one or more first insulation layers 11 may be reduced, which reduces the risk of the short circuit or the open circuit of the metal wirings 22 and improves the process yield of the metal wirings 22.

In some optional embodiments, as shown in FIG. 2 and FIG. 3, along the first direction X, the metal layer 2 and the interlayer insulation layer 111 are positioned between the edge insulation layer 112 and at least one of the second insulation layers 12, and an orthographic projection of each of the interlayer insulation layers 111 along the first direction X is staggered with the orthographic projection of the peripheral region 100b, that is, the orthographic projection of each of the interlayer insulation layers 111 along the first direction X is disposed outside the peripheral region 100b.

Specifically, the interlayer insulation layer 111 is provided between the second insulation layer 12 and the metal layer 2, and the edge insulation layer 112 is provided on a side of the metal layer 2 away from the second insulation layer 12. Orthographic projections of the interlayer insulation layers 111 along the first direction X are staggered with the orthographic projection of the peripheral region 100b along the first direction X, that is, the interlayer insulation layers 111 are provided only in the touch region 100a, but not in the peripheral region 100b. As such, the etching process of the metal wirings 22 on the organic material is avoided, which ensures desired bending property of the touch panel 100, and at the same time further reduces the risk of the short circuit or the open circuit of the metal wirings 22, which improves the process yield of the metal wirings 22. In addition, the second insulation layer 12 is provided on an outermost layer of the touch panel 100, which may better prevent water and oxygen from entering inside the touch panel 100 to better protect the internal circuit of the touch panel 100.

Optionally, since the interlayer insulation layers 111 are staggered with the peripheral region 100b (the interlayer insulation layers 111 are disposed outside the peripheral region 100b), the insulation layer 1 in the peripheral region 100b provided in a same layer as the interlayer insulation layer 111 may include the inorganic material, or the peripheral region 100b is formed with the organic material provided in a same layer as the interlayer insulation layer 111 after the metal wirings 22 are formed.

In some embodiments, as shown in FIG. 1, FIG. 2 and FIG. 3, the edge insulation layer 112 includes an insulation body 1121 and a protruding portion 1122 arranged on the insulation body 1121. The protruding portion 1122 protrudes from a side of the insulation body 1121 facing the metal layer 2 along the first direction X, and ones of the metal wirings 22 that are adjacent and arranged in a same layer are insulated from each other by the protruding portion 1122. The protruding portion 1122 insulates two adjacent metal wirings 22 from each other, which can reduce the risk of the short circuit or the open circuit of the metal wirings 22.

Specifically, after the metal wirings 22 are processed and formed in the second insulation layer 12, and after the processing of the metal wirings 22 is completed, the edge insulation layer 112 is deposited on the metal wirings 22, and the protruding portion 1122 of the edge insulation layer 112 is formed between adjacent metal wirings 22 in a same layer, so as to insulate adjacent metal wirings 22 from each other.

It should be noted that, the protruding portion 1122 may be provided only on a part of the insulation body 1121 positioned in the peripheral region 100b, or may be provided on parts of the insulation body 1121 in the touch region 100a and the peripheral region 100b. Any suitable manners of providing the protruding portion 1122 may be selected.

The above embodiments show a technical solution where the orthographic projection along the first direction X of the first insulation layer 11 disposed in the peripheral region 100b is smaller in area than the peripheral region 100b along the first direction X. An embodiment in which an orthographic projection along the first direction X of the second insulation layer 12 is smaller in area than the peripheral region 100b along the first direction X is described with reference to the drawings.

In some implementations, as shown in FIG. 5, the second insulation layer 12 includes a first insulation region 121 positioned in the touch region 100a and a second insulation region 122 positioned in the peripheral region 100b. An orthographic projection of the first insulation region 121 along the first direction X covers the touch region 100a, and an orthographic projection of the second insulation region 122 along the first direction X covers a plurality of first orthographic projections of the metal wirings 22 along the first direction X.

The first insulation region 121 of the second insulation layer 12 covers the touch region 100a, the second insulation region 122 of the second insulation layer 12 covers the metal wirings 22. Each of the touch electrodes 21 can be protected by the first insulation region 121, and the metal wirings 22 can be protected by the second insulation region 122, so that erosion of the touch electrodes 21 and the metal wirings 22 by water and oxygen is avoided, prevention of water and oxygen can also reduce metal residues left when the touch electrodes 21 and the metal wirings 22 are formed, and thereby a problem of a touch function failure of the touch panel 100 caused by the short circuit is effectively avoided.

Under a condition that, in a reliability test, the display panel used in the touch panel 100 is in a high-temperature and high-humidity environment, the second insulation layer 12 can further ensure that the metal layer 2 is not affected by water and oxygen, so that the metal layer 2 is not easily stripped off, heating caused by increased resistance is avoided, and desired touch effect is ensured.

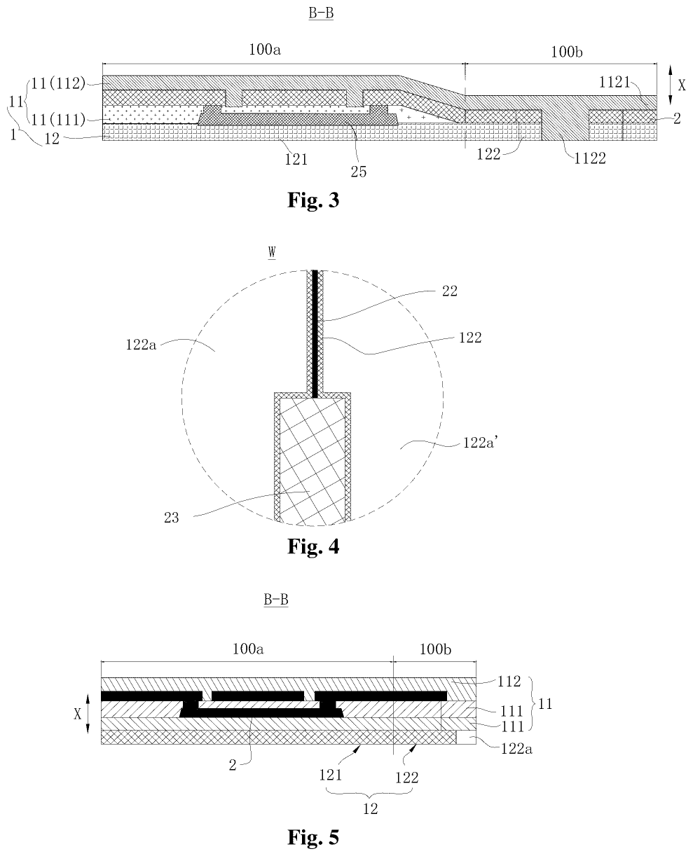

In some optional embodiments, the second insulation region 122 of the second insulation layer 12 is provided with at least one first via 122a. Optionally, the at least one first via 122a penetrates through the second insulation region 122 along the first direction X. As shown in FIG. 4 and FIG. 5, an orthographic projection of the first via 122a formed by enclosing along the first direction X is staggered with the first orthographic projections of the metal wirings 22 along the first direction X, that is, a second orthographic projection of a via wall of the first via 122a along the first direction X is staggered with the first orthographic projections of the metal wirings 22 along the first direction X. Specifically, the second orthographic projection of the via wall of the first via 122a along the first direction X does not overlap the first orthographic projections of the metal wirings 22 along the first direction X, that is, the via wall of the first via 122a does not overlap the metal wirings 22 along all directions perpendicular to the first direction X.

With provision of the first via 122a, when the layer structures such as the second insulation layer 12 are formed, stress can be well released through the first via 122a, so that the stress between the second insulation layer 12 and the first insulation layers 11 and/or the metal layer 2 can be matched, the second insulation layer 12 and the first insulation layers 11 and/or the metal layer 2 can be tightly attached, and connection adhesion is ensured to avoid occurrence of a bulging phenomenon when the touch panel 100 is formed and when low temperature environments change. At the same time, the first via 122a is staggered with the metal wirings 22, so that protection effect of the metal wirings 22 can be ensured, and the metal wirings 22 are not easily eroded by water and oxygen.

Optionally, when the second insulation layers 12 include multiple layers that are stacked, the first via 122a may penetrate through only one of the second insulation layers 12, or may penetrate through multiple of the second insulation layers 12, so that an effect of releasing the stress is achieved.

In some optional embodiments, as shown in FIG. 4, along a direction perpendicular to the first direction X, a gap exists between a boundary of the orthographic projection of the first via 122a along the first direction X and boundaries of the first orthographic projections of the metal wirings 22 along the first direction X. That is, the second insulation region 122 completely covers metal wirings 22 positioned in the peripheral region 100b, so that the metal wirings 22 positioned in the peripheral region 100b can be completely covered by the second insulation region 122 of the second insulation layer 12 to effectively prevent water and oxygen, and in a process of forming the metal wirings 22 by patterning the metal layer 2, a problem of the short circuit between the metal wirings 22 caused by the metal residues formed around the metal wirings 22 can be effectively avoided, which improves safety performance of the touch panel 100.

In some optional embodiments, a number of the at least one first via 122a is plural, and the plurality of first vias 122a are spaced along a direction perpendicular to the first direction X in the peripheral region 100b. Specifically, the plurality of first vias 122a may be spaced along a plurality of directions in a plane perpendicular to the first direction X, and may be distributed in a form of a rectangular array, a circular array, or other distribution forms. The plurality of first vias 122a are provided and spaced along a direction, so that a requirement of the second insulation layer 12 for releasing the stress in different positions of the peripheral region 100b is satisfied, and the bulging phenomenon caused by the stress in a process of forming and operation of the touch panel 100 is avoided.

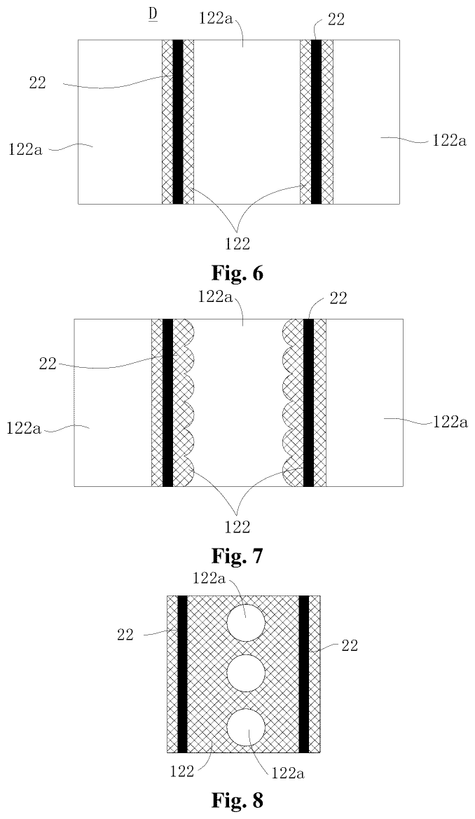

In yet other optional embodiments, as shown in FIG. 6 to FIG. 9, the first orthographic projection of the at least one first via 122a is in a shape of a polyline or a curve (that is, an orthographic projection of a sidewall of the first via 122a along the first direction X is in a shape of a polyline or a curve). Optionally, the sidewall of the first via 122a may be provided along extended trajectories of the metal wirings 22.

In some embodiments, the orthographic projection of the sidewall of the first via 122a along the first direction X may be in the shape of the curve, which may be a positive circular arc curve or an elliptical arc curve. Of course, as shown in FIG. 7, the orthographic projection of the sidewall of the first via 122a along the first direction X may be in the shape of a wavy line stitched together with a plurality of arcs.

As shown in FIG. 8 and FIG. 9, in some other examples, the orthographic projection of the sidewall of the first via 122a along the first direction X may be in the shape of a right circle or an ellipse. Of course, in some embodiments, the orthographic projection of the sidewall of the first via 122a along the first direction X may be in the shape of a polygon, such as a quadrilateral, a pentagonal, or the like.

The number of the at least one first via 122a between two adjacent metal wirings 22 may be one, or, of course, may be more than one, as long as the protection requirement of the metal wirings 22 can be satisfied, and the occurrence of the bulging phenomenon caused by the stress in the process of forming the touch panel 100 or in the process of the reliability test performed on the display panel used in the touch panel 100 is avoided.

As an optional embodiment, as shown in FIG. 4, the metal layer 2 is further provided with connection terminals 23 arranged in the peripheral region 100b. An end of at least one of the metal wirings 22 away from a corresponding one of the touch electrodes 21 is connected to a corresponding one of the connection terminals 23. The connection terminals 23 are provided to facilitate connection between the touch electrodes 21 and a corresponding driving IC (Integrated Circuit Chip), so as to control the touch electrodes 21 and collect touch positions. In addition, the connection terminals 23 and the metal wirings 22 are provided in the same layer, so that a forming process of the touch panel can be simplified, and at the same time, connection strength between the connection terminals 23 and the corresponding metal wirings 22 can be ensured.

In some optional embodiments, along the first direction X, an orthographic projection of the second insulation region 122 covers orthographic projections of the connection terminals 23. Since the connection terminals 23 are also formed by patterning the metal layer 2 and used to connect the metal wirings 22 to the driving IC, how to reduce a probability of the short circuit occurring between the connection terminals 23 is also very important. In the touch panel 100 according to the embodiments of the present application, along a stacking direction, that is, along the first direction X, the orthographic projection of the second insulation region 122 further covers the orthographic projections of the connection terminals 23 to prevent water and oxygen from a side of the second insulation layer 12, such as from an encapsulation layer 230, so that the short circuit occurring between adjacent connection terminals 23 caused by the metal residues formed around the connection terminals 23 is avoided, and the problem of the touch function failure of the touch panel 100 caused by the short circuit is further avoided.

As an optional embodiment, as shown in FIG. 4, in the second insulation region 122, a second via 122a′ is formed in an area between ones of the connection terminals 23 adjacent along a direction perpendicular to the first direction X. With the above arrangement, the requirement of releasing the stress in the process of forming the touch panel 100 can be further satisfied.

To satisfy a strength requirement of the touch panel 100 and facilitate the forming process, optionally, the second via 122a′ may be filled with the first insulation layers 11. The first via 122a and the second via 122a′ may be connected as one via or may be two vias.

The above embodiment shows a technical solution where along the first direction X, the orthographic projection of the second isolation region 122 of the second isolation layer 12 covers the first orthographic projections of the metal wirings 22.

In some other embodiments, the orthographic projection of the second isolation region 122 along the first direction X covers at least a part of the peripheral region 100b and is staggered with the first orthographic projections of the metal wirings 22. That is, the second insulation region 122 is arranged correspondingly to an area between the adjacent metal wirings 22 to protect the area between the adjacent metal wirings 22 and prevent the area from being eroded by water and oxygen.

In some optional embodiments, as shown in FIG. 14 to FIG. 17, the second insulation region 122 is provided with first grooves 122b arranged correspondingly to the metal wirings 22 along the first direction X. The first orthographic projections of the metal wirings 22 along the first direction X are positioned in respective ones of the first grooves 122b, and along the first direction X, the orthographic projection of the second insulation region 122 covers an area between two of the metal wirings 22 adjacent along a direction perpendicular to the first direction X.

The bendability property of the touch panel 100 is ensured by the first insulation layer 11, and at the same time, the second insulation layer 12 includes the first insulation region 121 and the second insulation region 122, and the touch electrodes 21 are protected by the first insulation region 121 to prevent the erosion of water and oxygen from an encapsulation structure of a display structure 200. The area between the two of the metal wirings 22 is covered by the second insulation region 122, so that water and oxygen from a side of the second insulation layer 12, such as from the encapsulation layer 230, can be prevented to avoid the short circuit between two adjacent metal wirings 22 caused by the metal residues formed on a side of the second insulation layer 12, such as the encapsulation layer 230, to further avoid the problem of the touch function failure of the touch panel 100 caused by the short circuit.

Under a condition that, in the reliability test, the display panel used in the touch panel 100 is in the high-temperature and high-humidity environment, the second insulation layer 12 can further ensure that the metal layer 2 is not affected by water and oxygen, so that the metal layer 2 is not easily stripped off, and the heating caused by the increased resistance can be avoided to ensure desired touch effects.

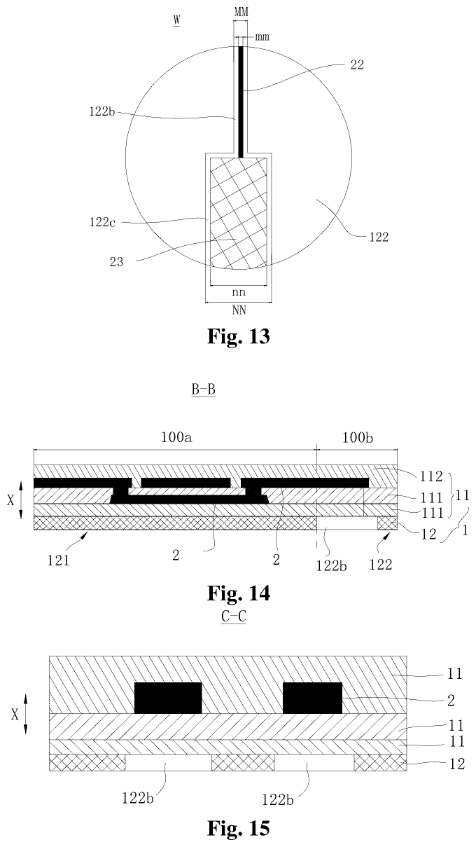

In an optional embodiment, along the direction perpendicular to the first direction X, as shown in FIG. 13, groove widths MM of the first grooves 122b are greater than line widths mm of respective ones of the metal wirings 22. Optionally, a gap exists between the boundaries of the first orthographic projections of the metal wirings 22 along the first direction X and boundaries of orthographic projections of groove walls of respective ones of the first grooves 122b along the first direction X. With the above arrangement, when the layer structures such as the second insulation layer 12 are formed, the stress can be well released through the first grooves 122b, so that the stress between the second insulation layer 12 and the first insulation layers 11 and/or the metal layer 2 can be matched, the second insulation layer 12 and the first insulation layers 11 and/or the metal layer 2 can be tightly attached, and the connection adhesion is ensured to avoid the occurrence of the bulging phenomenon when the touch panel 100 is formed or when high and the low temperature environments change.

Optionally, the metal wirings 22 according to the embodiments of the present application may be used as conductive lines between the touch electrodes 21 and the driving IC, and of course may further include a line for grounding, etc.

Optionally, the metal wirings 22 are matched with extended trajectories of the respective ones of the first grooves 122b. Dimensions of the metal wirings 22 on the extended trajectories are lengths of the metal wirings 22, and dimensions of the metal wirings 22 along a direction perpendicular to the extended trajectories of the metal wirings 22 and the first direction X are the line widths mm of the metal wirings 22. Similarly, widths of the first grooves 122b along the direction perpendicular to the extended trajectories of the metal wirings 22 and the first direction X are the groove widths MM of the first grooves 122b.

In an optional embodiment, as shown in FIG. 13, the second insulation region 122 is further provided with second grooves 122c arranged correspondingly to the connection terminals 23. The orthographic projections of the connection terminals 23 along the first direction X are positioned in respective ones of the second grooves 122c. The second insulation region 122 covers an area between adjacent two of the connection terminals 23. Since the connection terminals 23 are also formed by patterning the metal layer 2 and used to connect the metal wirings 22 to the driving IC, how to reduce the probability of the short circuit occurring between the connection terminals 23 is also very important. In the touch panel 100 according to the embodiments of the present application, the second insulation region 122 of the second insulation layer 12 is provided with the second grooves 122c arranged correspondingly to the connection terminals 23, so that the requirement of releasing the stress in the process of forming the layer structures such as the second insulation layer 12 can be satisfied. In addition, the area between the adjacent two of the connection terminals 23 can be ensured to be covered by the second insulation region 122, so that water and oxygen from a side of the second insulation layer 12, such as from the encapsulation layer 230, can be prevented to avoid the short circuit between the adjacent two of the connection terminals 23 caused by the metal residues formed on a side of the second insulation layer 12, such as the encapsulation layer 230, to further avoid the problem of the touch function failure of the touch panel 100 caused by the short circuit.

As an optional embodiment, as shown in FIG. 13, groove widths NN of the second grooves 122c are equal to or greater than widths nn of respective ones of the connection terminals 23. Optionally, a gap exists between boundaries of orthographic projections of the second grooves 122c along the first direction X and boundaries of the orthographic projections of the respective ones of the connection terminals 23 along the first direction X. With the above arrangement, the short circuit occurring between the connection terminals 23 can be avoided and the requirement of releasing the stress in the process of forming the layer structures such as the second insulation layer 12 can be further satisfied, so that the stress between the second insulation layer 12 and the first insulation layers 11 and/or the metal layer 2 can be matched, and the connection adhesion is ensured to avoid the occurrence of the bulging phenomenon when the touch panel 100 is formed.

As an optional implementation, in order to ensure strength of the touch panel 100 and simplify a forming process of the touch panel 100, the first grooves 122b and the second grooves 122c may be filled with the first insulation layer 11.

As an optional implementation, in the touch panel 100 according to the above embodiments of the present application, a number of metal layers 2 may be two. When the number of the metal layers 2 is two, at least one of the first insulation layer 11 and the second insulation layer 12 is provided between the two metal layers 2 and on sides of the two metal layers 2 facing away from each other, respectively, that is, the insulation layer 1 is provided between the two metal layers 2 and on sides of the two metal layers 2 facing away from each other, respectively. The touch electrodes 21 and the metal wirings 22 are respectively formed in one of the two metal layers 2 or both of the two metal layers 2. With the above arrangement, touch and bending requirements of the touch panel 100 can also be satisfied.

In an example, the plurality of touch electrodes 21 may be formed in one of the two metal layers 2. A bridge 25 is formed in the other of the two metal layers 2, and at least two of the touch electrodes 21 are electrically connected by the bridge 25.

In some optional embodiments, the plurality of touch electrodes 21 includes two or more touch driving electrodes 21a arranged in a matrix and two or more touch sensing electrodes 21b arranged in a matrix. Adjacent touch driving electrodes 21a in a same matrix row are electrically connected by one of a connecting portion 24 and the bridge 25, adjacent touch sensing electrodes 21b in a same matrix column are electrically connected by the other one of the connecting portion 24 and the bridge 25, and the connecting portion 24 is provided in a same layer as the touch driving electrodes 21a and the touch sensing electrodes 21b.

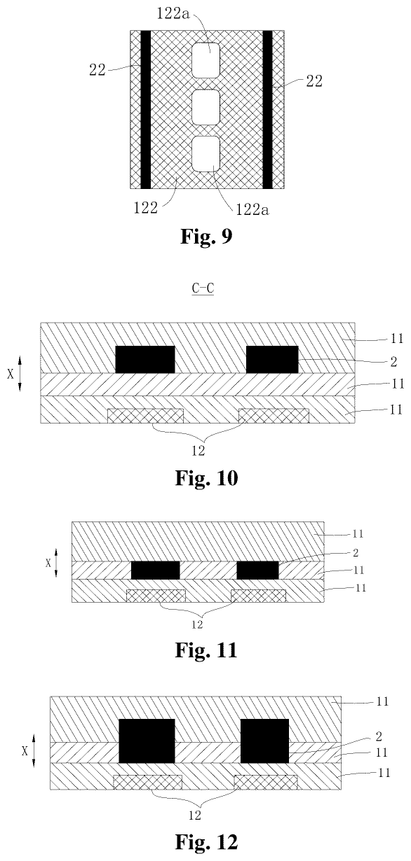

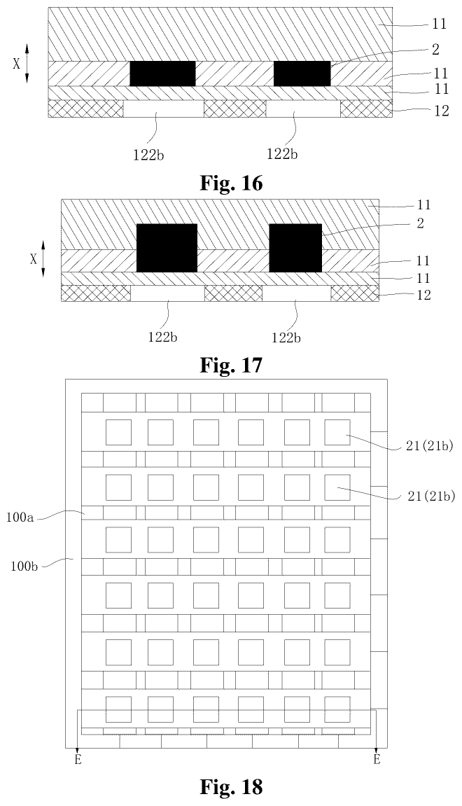

As shown in FIG. 1, FIG. 10, FIG. 11, FIG. 15, and FIG. 16, optionally, when the number of the metal layers 2 is two, the metal wirings 22 and the connection terminals 23 may be formed in one of the two metal layers 2. Optionally, the metal wirings 22 may be provided in a same layer as the plurality of touch electrodes 21 to form a structural form as shown in FIG. 10 and FIG. 15. Of course, in some embodiments, the metal wirings 22 may be provided in a same layer as the bridge 25 to form a structure form shown in FIG. 11 and FIG. 16, as long as a connection requirement between the touch electrodes 21 and the driving IC is satisfied. When the number of the metal layers 2 is two, the touch panel 100 may be in a form of self-capacitance or a mutual capacitance.

Of course, when the number of the metal layers 2 is two, providing the metal wirings 22 and the connection terminals 23 in a same layer as one of the two metal layers 2 is only an optional implementation. As shown in FIG. 12 and FIG. 17, in some embodiments, two metal layers 2 may be stacked in a predetermined region to form the metal wirings 22 and the connection terminals 23. With the above arrangement, impedance of the metal wirings 22 can be reduced and the touch effects of the touch panel 100 can be optimized.

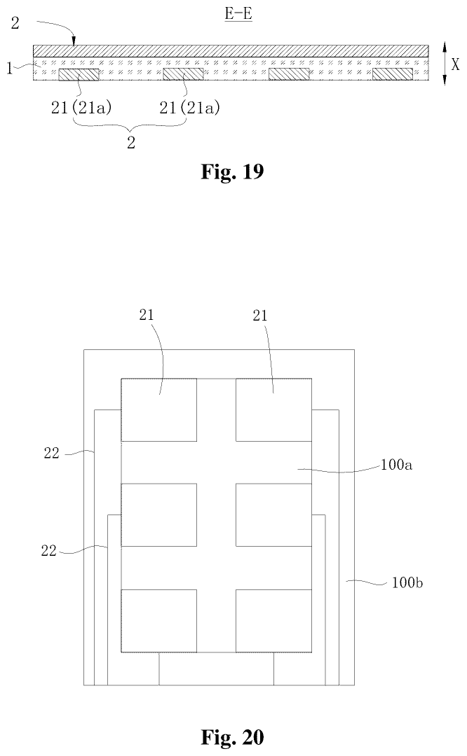

In an example, when the number of the metal layers 2 is two, the touch electrodes 21 of the metal layers 2 are not limited to be formed in one of the two metal layers 2. As shown in FIG. 18 and FIG. 19, in some embodiments, the plurality of touch electrodes 21 may be formed in the two metal layers 2. Similarly, the plurality of touch electrodes 21 may include the touch driving electrodes 21a and the touch sensing electrodes 21b, the touch electrodes 21 are formed in one of the two metal layers 2, and the touch sensing electrodes 21b are formed in the other one of the two metal layers 2.

In an example, one of the two metal layers 2 may include a plurality of longitudinal electrodes spaced along a transverse direction, and the other one of the two metal layers 2 may include a plurality of transverse electrodes spaced along a longitudinal direction. Capacitor is formed at places where the transverse electrodes intersect with the longitudinal electrodes. At the places where the transverse electrodes intersect with the longitudinal electrodes, the touch driving electrodes 21a are formed on one of the transverse electrodes and the longitudinal electrodes, and the touch sensing electrodes 21b are formed on the other of the transverse electrodes and the longitudinal electrodes. The touch driving electrodes 21a and the touch sensing electrodes 21b may be connected to the metal wirings 22, respectively. When an excitation signal is applied on the touch driving electrode 21a via the metal wiring 22, the excitation signal may be sensed and received on the touch sensing electrode 21b due to existence of the mutual capacitance, and a magnitude and a phase shift of a received signal are related to a frequency of the excitation signal and a value of the mutual capacitance, that is, a touch position may be determined by capacitance between the touch driving electrode 21a and the touch sensing electrode 21b. With the above arrangement, requirements of a touch function and a bending function of the touch panel 100 can also be satisfied.

It should be noted that, in the touch panel 100 according to the embodiments of the present application, when the number of the metal layers 2 is two, a number of the included second insulation layer 12 may be one. When the number of the included second insulation layer 12 is one, the second insulation layer 12 may be positioned on a side of one of the two metal layers facing away from the other one of the two metal layers 2, of course, the second insulation layer 12 may also be positioned between the two metal layers 2.

In an example, when the number of the metal layers 2 is two, the number of the second insulation layer 12 may be one, and the number of the first insulation layers 11 may be three. Along the first direction X, the arrangement manner of the layers may be the second insulation layer 12, the first insulation layer 11, the metal layer 2, the second insulation layer 12, the metal layer 2 and the second insulation layer 12. Of course, this is one of the arrangement manners, and in some embodiments, positions of the second insulation layers 12 may also be adjusted as needed, for example, in some embodiments, along the first direction X, the arrangement manner of the layers of the touch panel 100 may be the first insulation layer 11, the second insulation layer 12, the metal layer 2, the first insulation layer 11, the metal layer 2 and the first insulation layer 11.

Of course, the above arrangement manners of the second insulation layer 12, the first insulation layer 11 and the metal layer 2 are only some optional embodiments. The number of the second insulation layer 12 is not limited to be one, and the number of the first insulation layers 11 is not limited to be three. The number of the second insulation layers 12 and the first insulation layers 11, and the arrangement manner of the second insulation layer 12, the first insulation layer 11 and the metal layer 2 may be set according to bending performance requirement of the touch panel 100, the number of the metal layers 2 and protection levels against water and oxygen, which will not be listed one by one herein.

In the touch panel 100 according to the above embodiments, the number of the metal layers 2 being two is merely an optional implementation. As shown in FIG. 20, in some embodiments, the number of the metal layer 2 is one, the number of touch electrodes 21 is plural and the touch electrodes 21 are provided in a same layer, and each of the touch electrodes 21 is connected to one metal wiring 22, respectively. One side of the metal layer 2 along the first direction X is provided with the second insulation layer 12, and the other side of the metal layer 2 along the first direction X is provided with the first insulation layer 11. That is, the touch panel 100 may use a touch manner of self-capacitance, the touch electrodes 21 are connected to the driving IC by respective metal wirings 22, the metal wiring 22 is used to send a touch driving signal sent by the driving IC to the touch electrode 21, and the touch sensing signal generated by the touch electrodes 21 is transmitted back to the driving IC by the same metal wiring 22, so as to satisfy the requirements of the touch function of the touch panel 100. Optionally, when the number of the metal layer 2 is one, the metal wirings 22 and the connection terminals 23 are provided in a same layer as the touch electrodes 21.

As an optional implementation, in the touch panel 100 according to the above embodiments of the present application, the inorganic material of the second insulation layer 12 may be made of a combined material of one or more of silicon nitride, silicon oxide and silicon oxynitride. The organic material of the first insulation layer 11 may be made of a material such as OC glue, or the like. The metal layer 2 may be made of metal such as molybdenum, aluminium and copper or alloy.

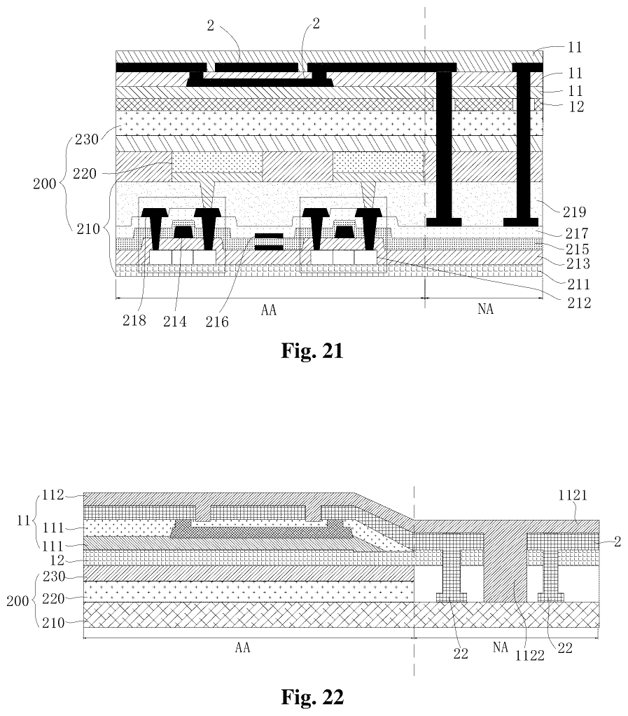

As shown in FIG. 21 and FIG. 22, in another aspect, the embodiments of the present application further provide a display panel including the touch panel 100 according to the above embodiments, which can satisfy the touch and bending requirements of the display panel, and can avoid occurrence of a display panel failure caused by the short circuit of the touch panel in the process of the reliability test or operation of the display panel.

In some optional embodiments, as shown in FIG. 21 and FIG. 22, the display panel according to the embodiments of the present application further includes a display structure 200 including an array substrate 210, a light-emitting layer 220 and an encapsulation layer 230 that are stacked. The touch panel 100 is provided with the encapsulation layer 230, and the second insulation layer 12 is provided between the metal layer 2 and the encapsulation layer 230. With the above arrangement, water and oxygen in the encapsulation layer 230 can be prevented by the second insulation layer 12, the short circuit caused by the metal residues between adjacent metal wirings 22 or the bulging phenomenon in the process of forming the touch panel 100 or the reliability test can be avoided, and performance of the display panel can be optimized.

In some optional embodiments, as shown in FIG. 21, the array substrate 210 of the display structure 200 has a plurality of pixel driving circuits arranged in an array for driving the light emitting layer 220. The pixel driving circuit includes a transistor. In an example, the array substrate 210 may include a substrate 211 and a device layer provided on the substrate 211. The device layer include an active layer 212, a first interlayer insulation layer 213, a first conductor layer, a second interlayer insulation layer 215, a second conductor layer, a third interlayer insulation layer 217, a third conductor layer and a planarization layer 219 that are stacked. The active layer 212 is used to form active regions of the transistors. The first conductive layer 214 is used to form gates of the transistors. The second conductive layer 216 and the first conductive layer 214 together form a storage capacitor of the array substrate 210. A third conductive layer 218 is used to form sources and drains of the transistors.

The light-emitting layer 220 may include a plurality of sub-pixels. Each of the sub-pixels includes an anode, a light-emitting material and a cathode. The light-emitting layer 220 is provided on the planarization layer 219, and the anodes are connected to the transistors to drive the sub-pixels by the array substrate 210, which satisfies display requirements of the display panel.

Optionally, the encapsulation layer 230 may be a thin film layer 230 and provided on a side of the light-emitting layer 220 away from the array substrate 210, and the touch panel 100 is stacked on the encapsulation layer 230. In some optional embodiments, the second insulation layer 12 and the first insulation layer 11 may be stacked between the metal layer 2 of the touch panel 100 and the encapsulation layer 230, and the second insulation layer 12 may be provided on a side close to the encapsulation layer 230 and stacked on the encapsulation layer 230. Of course, in some embodiments, the second insulation layer 12 may be away from the encapsulation layer 230, so that the first insulation layer 11 is positioned between the second insulation layer 12 and the encapsulation layer 230, as long as water and oxygen from the encapsulation layer 230 can be prevented, it can be avoided that water and oxygen from the inside of the encapsulation layer 230 on a side close to the encapsulation layer 230 and water and oxygen from the external environment on a side away from the encapsulation layer 230 along the first direction X act on the metal layer 2 of the touch panel 100 at the same time, and the probability of the short circuit between the metal wirings 22 positioned in the peripheral region 100b is reduced.

In some optional embodiments, the display structure 200 may include a display region AA and a bendable region NA. The touch region 100a of the touch panel 100 corresponds to the display region AA, and the peripheral region 100b of the touch panel 100 corresponds to the bendable region NA. The peripheral region 100b can be bent according to bending requirements. Optionally, the metal wirings 22 are connected, directly or via the connection terminals 23, to connection lines formed in the third conductive layer 218 on the array substrate 210, which satisfies binding requirements and facilitates connection with the driving IC, and ensures control over the array substrate 210 and the touch panel 100 of the display panel.

As an optional embodiment, the embodiments of the present application further provide a display apparatus including the display panel according to the above embodiments. The display apparatus may be any product or component with a display function, such as a mobile phone, a tablet computer, a notebook computer, a digital photo frame, or a navigator, and may be integrated with a photosensitive component such as a camera. Since the display apparatus according to the embodiments of the present application includes the display panel in any one of the above embodiments, the display apparatus has advantages of being not susceptible to short circuit and having high safety.

Those skilled in the art should understand that, the above embodiments are all illustrative rather than restrictive. Different technical features recited in different embodiments can be combined to achieve beneficial effects. Those skilled in the art should be able to understand and implement other modified embodiments of the disclosed embodiments on the basis of studying the drawings, the description, and claims. The functions of several parts recited in the claims can be implemented by a single hardware or software module. Some technical features are recited in different dependent claims, but it does not mean that these technical features cannot be combined to obtain beneficial effects.

What is claimed is:

1. A touch panel, comprising:
a touch region and a peripheral region arranged around the touch region,
at least one metal layer comprising a plurality of touch electrodes arranged in the touch region and a plurality of metal wirings connected to the touch electrodes and arranged in the peripheral region; and
at least two insulation layers stacked with the at least one metal layer along a first direction, at least one of the at least two insulation layers comprising an organic material and at least one of the at least two insulation layers comprising an inorganic material; and
wherein a gap exists between an edge of at least one of the at least two insulation layers and an edge of the peripheral region away from the touch region.

2. The touch panel according to claim 1, wherein a gap exists between an edge of the at least one insulation layer comprising the inorganic material and the edge of the peripheral region away from the touch region.

3. The touch panel according to claim 1, wherein an orthographic projection of the at least one insulation layer comprising the inorganic material along the first direction is at least partially not overlapped with an orthographic projection of the peripheral region along the first direction, or the orthographic projection of the at least one insulation layer comprising the inorganic material along the first direction does not overlap with the orthographic projection of the peripheral region along the first direction at all.

4. The touch panel according to claim 1, wherein an edge of the at least one insulation layer comprising the inorganic material is disposed at an edge of the touch region; or the edge of the at least one insulation layer comprising the inorganic material is disposed in a region between the edge of the touch region and the edge of the peripheral region away from the touch region.

5. The touch panel according to claim 1, wherein the at least one metal layer comprises two metal layers;
the touch electrodes are disposed at one of the two metal layers, a bridge is formed in the other of the two metal layers, and at least two of the touch electrodes are electrically connected by the bridge; or the touch electrodes are disposed at the two metal layers;
the at least one insulation layer comprising the inorganic material is disposed between the two metal layers; or the at least one insulation layer comprising the inorganic material is disposed at a side of one of the two metal layers away from the other of the two metal layers.

6. The touch panel according to claim 1, wherein the at least two insulation layers comprise first insulation layers, and the first insulation layers comprise one or more interlayer insulation layers and an edge insulation layer.

7. The touch panel according to claim 6, wherein an orthographic projection of at least one of the interlayer insulation layers along the first direction is disposed outside the peripheral region, and an orthographic projection of the edge insulation layer along the first direction covers both the touch region and the peripheral region.

8. The touch panel according to claim 6, wherein the at least two insulation layers comprise second insulation layers, and along the first direction, the at least one metal layer and the interlayer insulation layers are positioned between the edge insulation layer and at least one of the second insulation layers.

9. The touch panel according to claim 6, wherein an orthographic projection of each of the interlayer insulation layers along the first direction is disposed outside the peripheral region.

10. The touch panel according to claim 6, wherein the edge insulation layer comprises an insulation body and a protruding portion arranged on the insulation body, the protruding portion protrudes from the insulation body along the first direction, and adjacent ones of the metal wirings arranged in a same layer are insulated from each other by the protruding portion.

11. The touch panel according to claim 6, wherein the first insulation layers comprise the organic material.

12. The touch panel according to claim 8, wherein the at least one of the second insulation layers comprises a first insulation region positioned in the touch region and a second insulation region positioned in the peripheral region, an orthographic projection of the first insulation region along the first direction covers the touch region along the first direction, and an orthographic projection of the second insulation region along the first direction covers a plurality of first orthographic projections of the metal wirings along the first direction;
the at least one metal layer is formed with a plurality of connection terminals arranged in the peripheral region, and an end of at least one of the metal wirings away from a corresponding one of the touch electrodes is connected to a corresponding one of the connection terminals.

13. The touch panel according to claim 12, wherein along the first direction, the orthographic projection of the second insulation region further covers orthographic projections of the connection terminals.

14. The touch panel according to claim 12, wherein the at least one second insulation layer comprises the inorganic material.

15. A display panel, comprising:
a display structure comprising an array substrate, a light-emitting layer and an encapsulation layer that are stacked;
a touch panel disposed at one side of the display structure,
wherein the touch panel comprises:
a touch region and a peripheral region arranged around the touch region,
at least one metal layer comprising a plurality of touch electrodes arranged in the touch region and a plurality of metal wirings connected to the touch electrodes and arranged in the peripheral region; and
at least two insulation layers stacked with the at least one metal layer along a first direction, at least one of the at least two insulation layers comprising an organic material and at least one of the at least two insulation layers comprising an inorganic material; and
wherein a gap exists between an edge of at least one of the at least two insulation layers and an edge of the peripheral region away from the touch region.

16. The display panel according to claim 15, wherein the insulation layer for which there exists the gap between its edge and the edge of the peripheral region comprises the inorganic material.

17. The display panel according to claim 15, wherein the insulation layer for which there exists the gap between its edge and the edge of the peripheral region is disposed at a side of the at least one metal layer close to the display structure, or the insulation layer for which there exists the gap between its edge and the edge of the peripheral region is disposed at a side of the at least one metal layer away from the display structure.

18. The display panel according to claim 15, wherein the at least one metal layer comprises two metal layers, and the insulation layer for which there exists the gap between its edge and the edge of the peripheral region is disposed between the two metal layers.

19. The display panel according to claim 15, wherein the edge of the at least one of the at least two insulation layers is disposed between an edge of the touch region and the edge of the peripheral region away from the touch region.

20. A display apparatus, comprising the display panel according to claim 15.
